(19) United States
(12) Patent Application Publication
(10) Pub. No.: US 2014/0363787 A1
(43) Pub. Date: Dec. 11, 2014

(54) Expandable dental implant and method of use

(71) Applicant: Guido Ivo Tissi, Peschiera Borromeo (IT)

(72) Inventor: Guido Ivo Tissi, Peschiera Borromeo (IT)

(21) Appl. No.: 14/252,844

(22) Filed: Apr. 15, 2014

Related U.S. Application Data
(60) Provisional application No. 61/830,191, filed on Jun. 3, 2013.

(51) Int. Cl. A61C 8/00

(52) U.S. Cl. CPC A61C 8/0033; A61C 8/0022
USPC 433/174; 433/173

(57) ABSTRACT

An expandable dental implant for implantation in the bone of the jaw of a patient includes a body which has a longitudinal axis. An opening is disposed in the body. An anchor is slidably received by the opening, the anchor being slidable in a direction perpendicular to the longitudinal axis. When a healing or stump screw is screwed down into the implant, the screw contacts an angled part of the anchor and forces the anchor outward and into the bone of the jaw. In an embodiment a sealing device is used to seal the implant prior to installing a healing or stump screw.

### CROSS REFERENCE TO RELATED APPLICATION

This application claims the filing benefit under 35 U.S.C. §119(e) of U.S. Provisional Application No. 61/830,191 filed Jun. 3, 2013, which is hereby incorporated by reference.

### TECHNICAL FIELD

The present invention pertains generally to dental implants, and more particularly to an expandable dental implant which includes laterally moving anchors for holding the implant in place.

### BACKGROUND OF THE INVENTION

Dental implants are used to replace missing teeth and are well known in the art. The dental implant is usually made of titanium, and is placed in and fuses with the bone of the upper or lower jaw in a process known as “osseointegration”. The implant process is typically divided into two phases. First the implant is inserted into the bone of the jaw. Then after a waiting period of 2-3 months in which osseointegration occurs, the abutment/crown is installed. A problem exists however in that during abutment/crown installation the implant can become loose and rotate. That is, when the screw is removed sometimes the applied rotational force can also unscrew the implant body. Even a small unscrewing means a break of the new bone tissues, and can cause lesions and therefore negate the osseointegration which has taken place.

Expandable dental implants are also known in the art. In one type of expandable dental implant the body of the implant expands by bending. A problem however exists with this technical approach. Dental implants are preferably made from medical grade titanium in order to provide superior bone integration. However, medical grade titanium is brittle and breaks if it is bent. As such, devices which rely on bending are not compatible with medical grade titanium. Additionally, prior art devices have lateral openings which interfere during the screwing of the implant into the bone. The lateral openings (fissures) can catch bone, tissue, and blood and transfer them into the implant. The bone, tissue, and blood can then osteointegrate with the inner parts of the implant and screw and impede or prevent removal. Also, the lateral openings will expose bone tissue to contamination during reopening of the head of the implant (e.g. when taking out the healing screw to insert the stump screw with the crown).

### BRIEF SUMMARY OF THE INVENTION

The present invention is directed to an expandable dental implant which provides improved bone anchoring. One or more laterally movable anchors expand by sliding outwardly from the body of the implant and into the bone, and as such serve as an anti-rotational device. The outward movement of the anchors is caused by the downward motion of the healing abutment screw or by the stump abutment screw. The top inside part of the anchor is angled, so as the screw is rotated downward, it abuts the anchor and pushes the anchor outward perpendicular to the motion of the screw. The outwardly expanding anchor provides superior anti-rotation mechanical anchoring to the bone as compared to existing implants.

The anchors can be of different sizes and shapes: for example rectangular, square, elliptical depending the size of the dental implant and the force to be exerted on the bone. The depth of the anchors can be selected to best accommodate the density of the bone: thinner in cases of compact bone, thicker in cases of porous bone. In the case of porous bone or “soft” bone tissue the anchors increased depth offers a immediately greater mechanical seal and anchoring. Furthermore, horizontal compression of the bone tissues made by the anchors increases the local density of the bone itself and can result in faster and increased bone integration. In the case of immediate crown installation (installation of the stump screw abutment immediately after the implant installation): the anchors provide a superior mechanical seal both vertical and longitudinal to the masticatory loads, than that which is offered by simple thread and coils of the current design implants.

The expandable dental implant of the present invention provides better, immediate anchoring to the bone. In the case of the classical technique (for bone tissue integration waiting time of 2-3 months between phase 1 implant installation and phase 2 abutment/crown installation): during the re-opening after the initial period of osseointegration the expandable dental implant avoids the frequent problems due to blocking of the healing abutment for clots and debris, which causes partial loosening or moving the implant in a circular direction. This also avoids the resulting micro-lesions of bone fibers already in the process of osseointegration.

In accordance with an embodiment, an expandable dental implant for implantation in the bone of the jaw of a patient includes a body which has a longitudinal axis. An opening is disposed in the body. An anchor is slidably received by the opening, the anchor being slidable in a direction perpendicular to the longitudinal axis.

In accordance with another embodiment, the expandable dental implant cooperates with a screw. The anchor has an inner part which is beveled, so that when the screw is screwed along the longitudinal axis the screw contacts the inner part of the anchor and urges the anchor outward perpendicular to the longitudinal axis.

In accordance with another embodiment, the expandable dental implant cooperates with a screw, and includes a sealing device for sealing the expandable dental implant. The anchor has an inner part which is beveled, so that when the sealing device is inserted along the longitudinal axis the sealing device contacts the inner part of the anchor and urges the anchor outward perpendicular to the longitudinal axis. The screw is threadably receivable by the body after the sealing device has been inserted.

In accordance with another embodiment, the sealing device is a screw.

In accordance with another embodiment, the body has a first threaded hole for receiving the screw, and a second hole for receiving the sealing device, the first threaded hole for receiving the screw having a larger diameter than the second hole for receiving the sealing device.

In accordance with another embodiment, the expandable dental implant has an unexpanded state in which the anchor does not outwardly project from the body, and an expanded state in which the anchor outwardly projects from the body. The body has external threads, and the anchor has external threads which align with the external threads of the body when the expandable dental implant is in the unexpanded state.

In accordance with another embodiment, when the dental implant is in the expanded state, part of the anchor remains in the body.

In accordance with another embodiment, retaining means are provided for holding the anchor within the opening.

In accordance with another embodiment, the opening and the associated anchor are one of (1) rectangular, (2) square, (3) elliptical, and (4) circular.

In accordance with another embodiment, a plurality of the openings and associated anchors are provided, the plurality of the openings and associated anchors are circumferentially spaced around the body.

In accordance with another embodiment, the circumferential spacing being one of (1) two the openings and associated anchors spaced 180° apart, (2) three the openings and associated anchors spaced 120° apart, and (3) four the openings and associated anchors spaced 90° apart.

In accordance with another embodiment, providing two openings and associated anchors, the two openings and associated anchors being of different shapes.

In accordance with another embodiment, providing two openings and associated anchors, the two openings and associated anchors being of different sizes.

In accordance with another embodiment, a spacing of about 0.002 inches existing between the opening and the anchor.

In accordance with another embodiment, the anchor having a depth which determines how far the anchor will expand into the bone of the jaw.

In accordance with another embodiment, the anchor is not externally threaded; and the body is not externally threaded in the vicinity of the anchor.

In accordance with another embodiment, the expandable dental implant cooperates with a screw, and the patient has a mouth which contains microbes. Sealing means are provided for sealing the expandable dental implant so that the microbes from the patient's mouth cannot pass through the opening and into the bone of the jaw.

In accordance with another embodiment, the screw includes a gasket and the body includes a seat for the gasket. When the screw is screwed into the body, the gasket forms a seal.

Other embodiments, in addition to the embodiments enumerated above, will become apparent from the following detailed description, taken in conjunction with the accompanying drawings, which illustrate, by way of example, the principles of the expandable dental implant and method of use.

### BRIEF DESCRIPTION OF THE DRAWINGS

FIG. 1 is a side elevation view of an embodiment of an expandable dental implant in an unexpanded state;

FIG. 2 is a side elevation view of the implant in a partially expanded state;

FIG. 3 is a side elevation view of the implant in an expanded state;

FIG. 4 is a top plan view of the implant;

FIG. 5 is another side elevation view of the implant;

FIG. 6 is a perspective view of the implant;

FIG. 7 is a cross sectional view along the line 7-7 of FIG. 4 showing the implant in the expanded state;

FIG. 8 is a cross sectional view as in FIG. 7 showing the implant in the unexpanded state;

FIG. 9 is a top plan view of an anchor;

FIG. 10 is a side elevation view of the anchor;

FIG. 11 is a top plan view of a different anchor;

FIG. 12 is a side elevation view of the different anchor;

FIG. 13 is a top plan view of another embodiment of the implant;

FIG. 14 is a side elevation view of the embodiment of FIG. 13;

FIG. 15 is a perspective view of the embodiment of FIG. 13;

FIG. 16 is a top plan view of an another embodiment of the implant;

FIG. 17 is a side elevation view of the embodiment if FIG. 16;

FIG. 18 is a perspective view of the embodiment of FIG. 16;

FIG. 19 is a top plan view of another embodiment of the implant;

FIG. 20 is a side elevation view of the embodiment of FIG. 19;

FIG. 21 is a perspective view of the embodiment of FIG. 19;

FIG. 22 is a top plan view of another embodiment of the implant;

FIG. 23 is a side elevation view of the embodiment of FIG. 22;

FIG. 24 is a perspective view of the embodiment of FIG. 22;

FIG. 25 is a top plan view of another embodiment of the implant;

FIG. 26 is a side elevation view of the embodiment of FIG. 25;

FIG. 27 is a perspective view of the embodiment of FIG. 25;

FIG. 28 is a side elevation view of another embodiment of the implant;

FIG. 29 is an opposite side elevation view of the embodiment of FIG. 28;

FIG. 30 is a side elevation view of another embodiment of the implant;

FIG. 31 is a side elevation view of the expandable dental implant with sealing means;

FIG. 32 is a simplified fragmented perspective view of a gasket and seat seal before sealing;

FIG. 33 is a simplified fragmented perspective view of the gasket and seat seal after sealing;

FIG. 34 is an exploded side elevation view of another embodiment of the implant showing a sealing device ready to be installed;

FIG. 35 is a side elevation view of the sealing device installed in the implant;

FIG. 36 is an exploded side elevation view of a screw being installed after the sealing device; and,

FIG. 37 is a cross sectional view along the line 37-37 of FIG. 36.

### DETAILED DESCRIPTION OF THE INVENTION

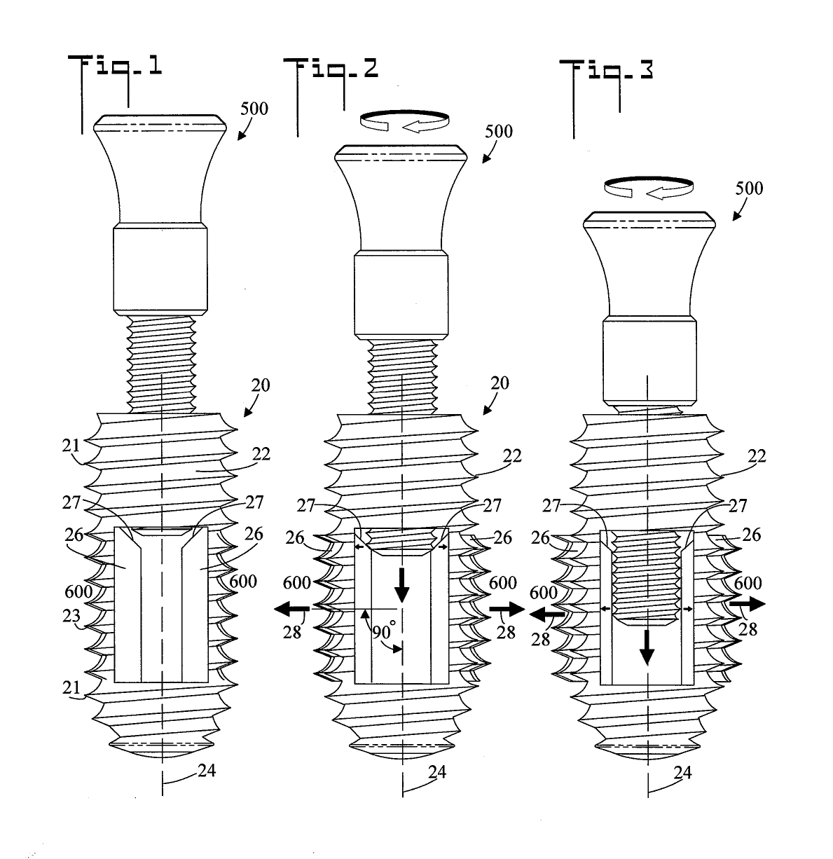

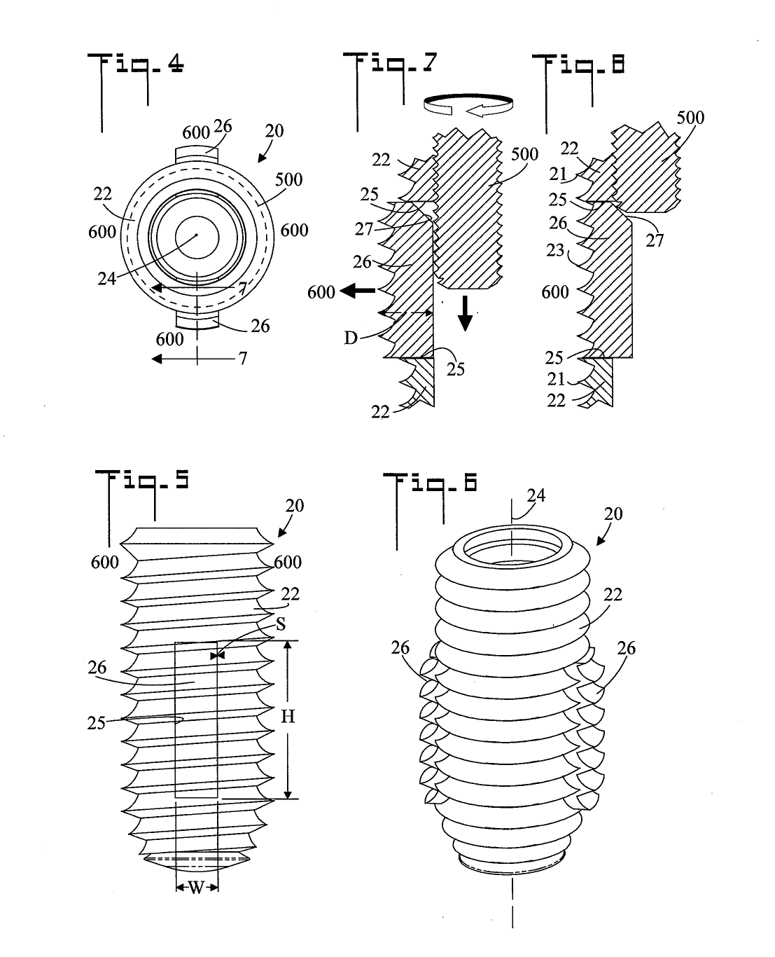

Referring initially to FIGS. 1-3, there are illustrated side elevation views of a first embodiment of an expandable dental implant 20 for implantation in the bone of the jaw 600 of a patient. Expandable dental implant 20 cooperates with a screw 500 (healing screw or stump screw). In FIG. 1, expandable dental implant 20 is in an unexpanded state. In FIGS. 2 and 3 expandable dental implant 20 is in an expanded state. It is noted that FIGS. 1-3 have a cutaway section which shows the internal features of expandable dental implant 20, and that expandable dental implant 20 has been implanted in a user and is surrounded by bone 600. FIGS. 4-6 are top plan, side elevation, and perspective views respectively of expandable dental implant 20. It is noted that FIGS. 4-5 are rotated 90° with respect to FIGS. 1-3.

Expandable dental implant 20 includes a threaded body 22 which has a longitudinal axis 24. An opening (window) 25 is disposed in body 22. An anchor 26 is slidably received by opening 25. Anchor 26 is slidable in a direction 28 which is perpendicular to longitudinal axis 24. In the embodiment of FIGS. 1-6, two contrapositioned anchors 26 are utilized, however a lesser or greater number may also be used as is described below.

In the unexpanded state of FIG. 1, anchor 26 does not outwardly project from body 22. In the expanded state of FIGS. 2 and 3, anchor 26 outwardly projects from body 22. In FIG. 2, expandable dental implant 20 is partially expanded, and in FIG. 3, expandable dental implant 20 is fully expanded. Referring specifically to FIGS. 1 and 8, the outside surface of body 22 has external threads 21. Anchor 26 has external threads 23 which align with external threads 21 of body 22 when expandable dental implant 20 is in the unexpanded state. That is, in the unexpanded state of FIG. 1, threads 21 and 23 are in line so that expandable dental implant 20 can be screwed into the bone 600 (rundown).

In FIG. 2, anchor 26 is beginning to be outwardly moved in direction 28 by screw 500 and expandable dental implant 20 is in a partially expanded state. Anchor 26 has an inner part 27 which is beveled (angled at the top as shown), so that when screw 500 is screwed along longitudinal axis 24 as in FIG. 2, screw 500 contacts inner part 27 of anchor 26 and urges anchor 26 outward in direction 28 perpendicular to longitudinal axis 24 and into bone 600.

In FIG. 3, screw 500 has moved (been screwed) down further so that it contacts the inner wall of anchor 26, and resultantly expandable dental implant 20 is in a fully expanded state. As such, anchor 26 is forced into the bone 600 and serves to lock expandable dental implant 20 in place in bone 600, and very importantly prevents expandable dental implant implant 20 from rotating. In a feature of the invention, anchor 26 moves linearly perpendicularly to longitudinal axis 24. As such, no bending of anchor 26 is required.

Referring to FIG. 5, in the shown embodiment, opening 25 and associated anchor 26 are rectangular and have a height H and a width W. However it may be appreciated that the size and shape of opening 25/anchor 26 can be varied to best suit bone density and other implant needs. For example, opening 25/anchor 26 can be rectangular, square, circular, elliptical or any other shape depending upon the particular implant situation. Also in the shown embodiment, two anchors 26 are equally spaced around the circumference of body 22 (i.e. 180° apart). However, it may be appreciated that depending on particular dental needs, the spacing could be non-equidistant such as the two anchors 26 being 90° apart. This equidistant or non-equidistant spacing can also apply to the three and four anchor embodiments discussed below. It is also noted that while as shown both anchors 26 are the same size and shape, it is also possible to use different size and shape anchors 26 in the same implant 20. For example, one anchor 26 could be rectangular as shown, and the other anchor 26 could be square, circular, or oval as is discussed below.

FIGS. 4-6 show top plan, side elevation, and perspective views respectively of the two anchor 26 first embodiment of expandable dental implant 20 shown in FIG. 1 in the expanded state. A healing screw 500 (refer to FIGS. 1-3) has been used to force anchors 26 to outwardly expand perpendicular to longitudinal axis 24. Healing screw 500 has then been removed such as would happen just prior to the installation of stump screw 500. It is also noted that the spacing (clearance) S between anchor 26 and opening 25 in body 22 into which anchor 26 fits is in the order of 0.002 inches (0.05 mm) around the entire perimeter of anchor 26. It is noted that this tolerance can vary somewhat depending upon the fabrication process which is used. This close spacing ensures a tight seal which prevents the undesirable ingress of bone, tissue, or blood into expandable dental implant 20. It is noted in FIG. 4, that screw 500 is also shown in dashed lines.

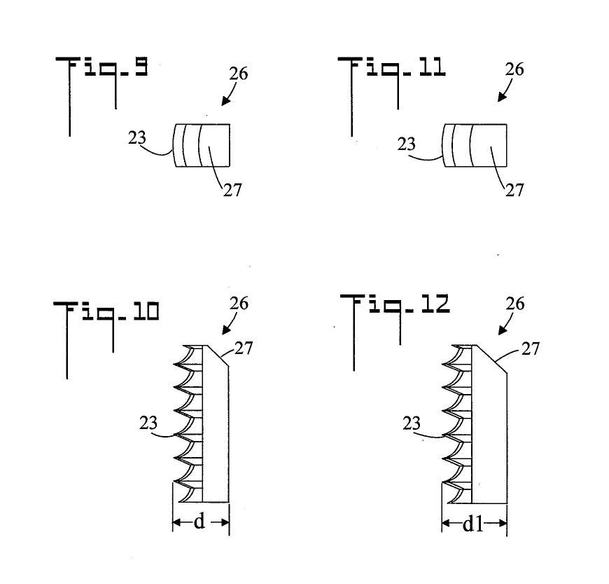

FIG. 7 is a cross sectional view along the line 7-7 of FIG. 4 showing expandable dental implant 20 in the expanded state as in FIGS. 2 and 3, and FIG. 8 is a cross sectional view as in FIG. 7 showing expandable dental implant 20 in the unexpanded state as in FIG. 1. Anchor 26 is in the unexpanded state of FIG. 8 during initial placement in the bone 600. It is noted that for discussion purposes FIGS. 7 and 8 also include screw 500. In the unexpanded state of FIG. 8 anchor 26 does not outwardly project from body 22, and in the expanded state of FIG. 7 anchor 26 outwardly projects from body 22. It is noted that when expandable dental implant 20 is in the expanded state of FIG. 7, part of anchor 26 remains in body 22. This retention is effected by retaining means for holding anchor 26 within opening 25, so that anchor 26 does not fall out of opening 25 during handling of expandable dental implant 20 prior to insertion into the bone 600. For example, the surface of anchor 26 could include friction enhancing bumps so that it is friction fit into opening 25. Then it would not become detached during normal handling, but the friction would break under pressure from screw 500 when turned by a manual screwdriver or power tool. Another retaining means would be to use a bio-compatible adhesive.

In FIG. 7 it is noted that the lateral depth D of anchor 26 determines how far anchor 26 will protrude from body 22 (also refer to FIGS. 9-12 and the associated discussions). In FIGS. 7 and 8, it is noted that body 22 has inside threads which engage the threads of screw 500. Also, after rundown when screw 500 is removed (unscrewed) from body 22, the compression force exerted on the bone 600 walls by anchors 26 ceases.

Because anchor 26 provides a better immediate grip of the bone 600, the size of the hole into which expandable dental implant 20 is screwed can be larger than that used with standard implants. This reduces the force applied by the manual or power tools needed to screw expandable dental implant 20 into the bone 600. This means:

1. The implant process is atraumatic with lower stress to the bone 600 and tissues during screwing.

2. There is a lower risk of breaking the expandable dental implant 20 components. Sometimes the force applied is over 50 newton metres (nm), and it is known by dentists that the head of implants and/or the connecting tools and screwdriver can break or be damaged.

3. An easier and faster implant insertion process.

In an embodiment, the hole size can be 5% to 10% larger, depending upon the hardness of the bone 600: hard bone 5-10%, medium bone 3-7%, soft bone 0-3%. These numbers are approximate and will vary as a function of specific implant needs.

FIGS. 9 and 10 are top plan and side elevation view respectively of the rectangular anchor 26 of FIGS. 1-8. Anchor 26 has a depth d which determines how far it will expand into the bone 600 of the jaw. The greater the depth, the greater the expansion distance into the bone 600. It is noted that the exterior surface of anchor 26 includes threads 23 which match the threads 21 of body 22 (refer to FIGS. 1 and 8).

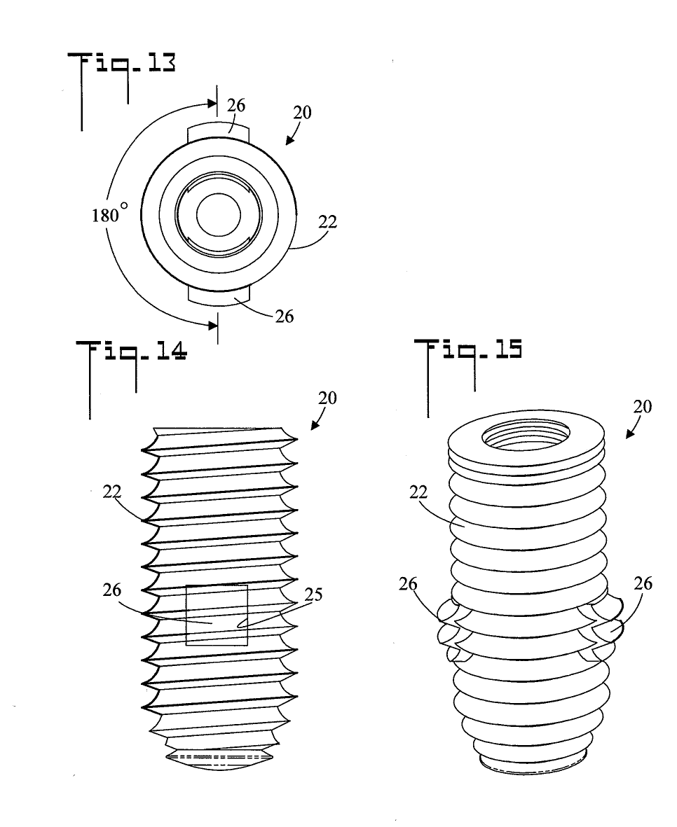

FIGS. 11 and 12 are top plan and side elevation views respectively of a different anchor 26. In this embodiment, anchor 26 has a depth d1 which is greater that depth d of FIGS. 9-10. As such, when activated by screw 500, this anchor 26 will expand a greater distance from body 22. This wider embodiment is more useful when anchoring expandable dental implant 20 in porous bone. It is noted however, that regardless of the expansion distance, anchor 26 never breaks contact with body 22. That is, mechanical means are provided to prevent anchor 26 from separating from body 22. This ensures that a tight seal between anchor 26 and body 22 is always maintained to prevent the entry of tissue or bone into expandable dental implant 20. It is also noted that expandable dental implant 20 can be used with any type of implant head such as exagonal internal, exagonal external, conical, penta, quadra, trio, etc. Also, the external surface of anchor 26 (just like the surface of body 22) can be designed to promote osseointegration (e.g. sandblasted, micro-holes, coated with bio-particles, etc.)

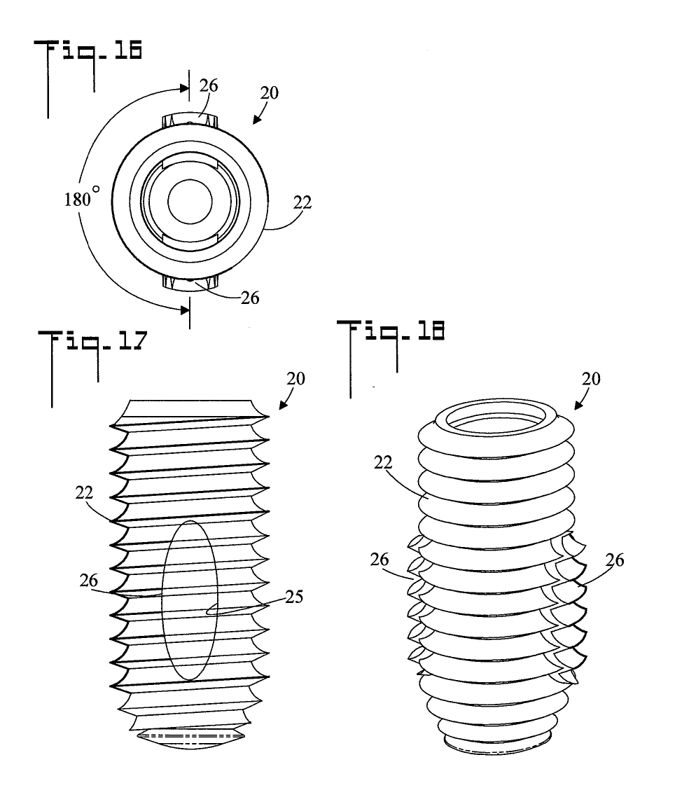

FIGS. 13-15 are top plan, side elevation, and perspective views respectively of another embodiment of expandable dental implant 20. This embodiment has two openings 25 and associated anchors 26 (i.e. opening/anchor pairs), which are square and circumferentially spaced 180° apart.

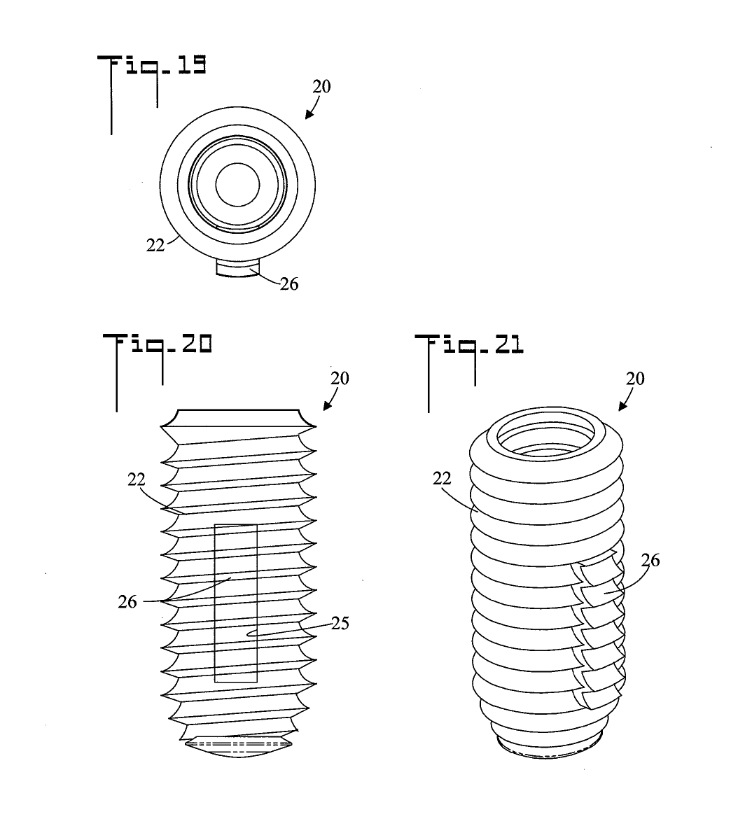

FIGS. 16-18 are top plan, side elevation, and perspective views respectively of another embodiment of expandable dental implant 20. This embodiment has two openings 25 and associated anchors 26, which are elliptical and spaced 180° apart.

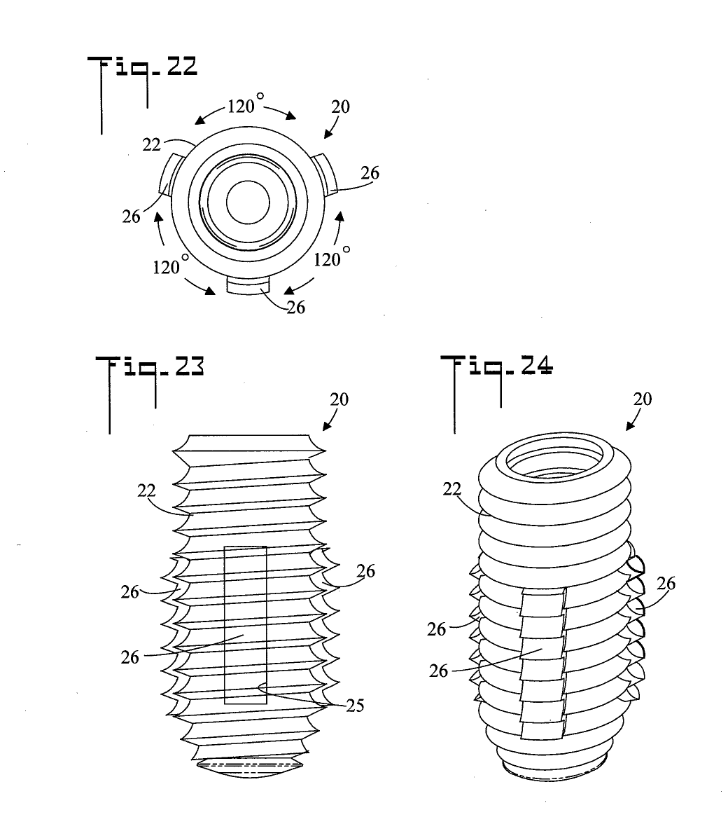

FIGS. 19-21 are top plan, side elevation, and perspective views respectively of another embodiment of expandable dental implant 20. This embodiment has one opening 25 and associated anchor 26 which is rectangular.

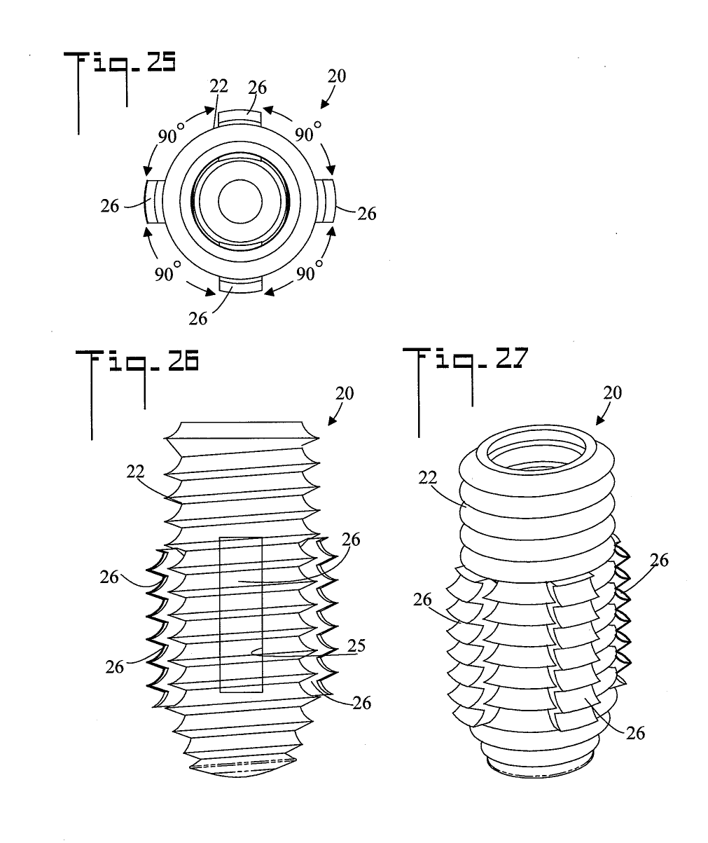

FIGS. 22-24 are top plan, side elevation, and perspective views respectively of another embodiment of expandable dental implant 20. This embodiment has three openings 25 and associated anchors 26, which are rectangular and spaced 120° apart.

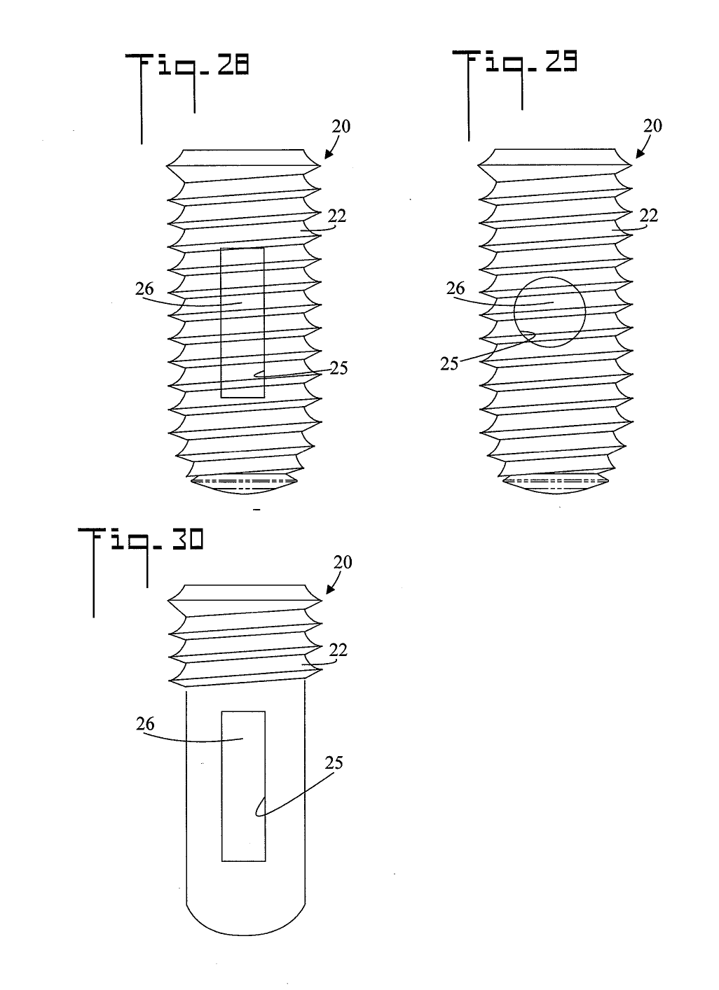

FIGS. 25-27 are top plan, side elevation, and perspective views respectively of another embodiment of expandable dental implant 20. This embodiment has four openings 25 and associated anchors 26, which are rectangular and spaced 90° apart.

FIG. 28 is a side elevation view of another embodiment of expandable dental implant 20, and FIG. 29 is an opposite side elevation view of the embodiment of FIG. 28. This embodiment has two openings 25 and associated anchors 26, wherein the two openings 25 and associated anchors 26 are of different shapes and sizes. One opening 25/anchor 26 pair is rectangular, and the other opening 25/anchor 26 pair is circular.

FIG. 30 is a side elevation view of another embodiment of expandable dental implant 20. In this embodiment anchor 26 is not externally threaded, and body 26 is not externally threaded in the vicinity of anchor 26. In this embodiment expandable dental implant is not screwed in bone 600, but is rather pushed down. Other features of this embodiment of expandable dental implant 20 are as previously described.

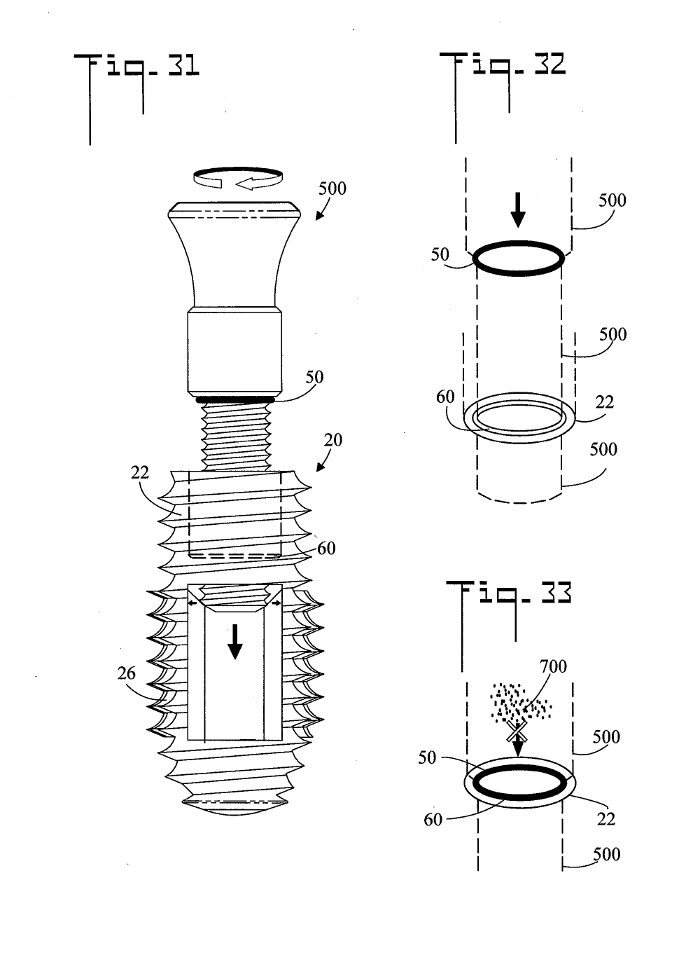

FIG. 31 is a side elevation view of expandable dental implant 20 with sealing means which prevents microbes from passing from the mouth, through expandable dental implant 20, and into the bone 600. FIG. 32 is a simplified fragmented perspective view of a gasket 50 and seat 60 seal before sealing, and FIG. 33 is a simplified fragmented perspective view of the gasket 50 and seat 60 seal after sealing. Expandable dental implant 20 cooperates with a screw 500, and the patient has a mouth which contains microbes 700. Sealing means are provided for sealing expandable dental implant 30 so that microbes 700 from the patients mouth cannot pass through opening 25 (refer to FIG. 5) and into the bone of the jaw 600. In the shown embodiment, screw 500 includes a gasket 50 (such as a circular O-ring) and body 22 includes a seat 60 for gasket 50. When screw 500 is screwed down into body 22, gasket 50 abuts seat 60 and forms a seal between screw 500 and body 22. Gasket 50 can be made from medical grade silicone, nylon, polytetrafluoroethylene, pmma, etc. In another embodiment, the sealing means can simply be a precision metal contact between the shoulder of screw 500 and seat 60 inside body 22. In another embodiment a sealing compound could be applied to the junction of screw 500 and body 22 to effect the seal.

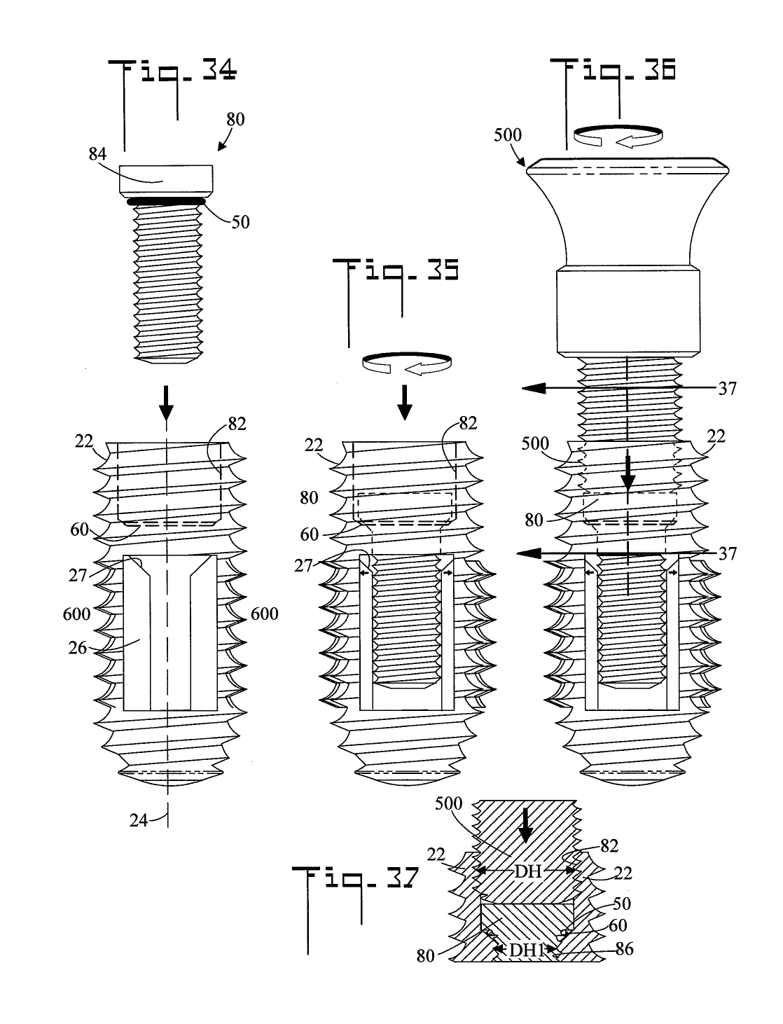

FIG. 34 is an exploded side elevation view of another embodiment of expandable dental implant 20 showing a sealing device 80 ready to be installed, FIG. 35 is a side elevation view of the sealing device 80 installed in the implant, FIG. 36 is an exploded side elevation view of a screw being installed after the sealing device 80, and FIG. 37 is a cross sectional view along the line 37-37 of FIG. 36. A sealing device 80 is provided for sealing expandable dental implant 20. Sealing device 80 is first passed through first threaded hole 82 in body 22 which will later receive screw 500. First threaded hole 82 is of sufficient diameter so that it can pass the head 84 of sealing device 80. In the shown embodiment, sealing device 80 is a screw the shank of which is threaded so that it can be screwed into a second hole 86 (threaded) in body 22 to effect insertion. However, in another possible embodiment sealing device 80 and second hole 86 are not threaded, but rather sealing device 80 is press fit into second hole 86 in body 22. Similar to the embodiment of FIGS. 31-33, sealing device 80 includes a gasket 50 which engages a seat 60 in body 22 to effect the seal of body 22 and prevent mouth originating microbes 700 from passing through opening 25 and into bone 600 (refer to FIGS. 31-33 and the associated discussions). Anchor 26 has an inner part 27 which is beveled, so that when sealing device 80 is inserted along longitudinal axis 24 sealing device 80 contacts inner part 27 of anchor 26 and urges anchor 26 outward perpendicular to longitudinal axis 24. Screw 500 is then threadably receivable by first threaded hole 82 in body 22 after sealing device 80 has been inserted. In other words, in this embodiment it is sealing device 80, and not screw 500, which outwardly expands anchor 26. Screw 500 is installed after sealing device 80 has sealed body 22 (refer to FIG. 36). Once sealing device 80 has been installed and the seal created, it is not removed. FIG. 35 shows sealing device 80 inserted in body 22 so as to effect the seal.

Referring to FIG. 37, screw 500 (healing or stump) is threadably receivable by threaded hole 82 in body 22 after sealing device 22 has been inserted so that screw 500 abuts sealing device 80. In other words, after sealing device 80 has been installed, screw 500 is screwed down into abutting relationship with sealing device 80. Because sealing device 80 has sealed body 22, screw 500 can be inserted and removed multiple times without breaking the seal made by the sealing device 80. It is noted that the diameter DH of first threaded hole 82 for receiving screw 500 is greater than the diameter DH1 of second hole 86 for receiving sealing device 80. In the shown embodiment, this relationship is necessary since the head 84 of sealing device 80 must be able to pass through first threaded hole 82.

In an embodiment, expandable dental implant 20 including sealing device 80 are disposed in a sterile package. Sealing device 80 is already installed in body 22 of expandable dental implant 20 in a position ready to be screwed down. The procedure is then: (1) unpack dental implant 20 including sealing device 80, (2) screw expandable dental implant 20 into bone 600, (3) screw sealing device 80 down into body 22 of expandable dental implant 20 thereby causing anchors 26 to be pushed out and into bone 600, and (4) screw screw 500 into expandable dental implant 20.

Some of the features of expandable dental implant 20 are listed below: (refer to FIGS. 1-37)

1. In expandable dental implant 20 the anchors 26 slide horizontally (i.e. perpendicular to the longitudinal axis 24 of body 22) into the bone 600 under the force of screw 500.

2. Both body 22 and anchors 26 are made of medical grade titanium and are not subjected to any bending force. The force is exerted by screw 500 which pushes against the inner part 27 of anchors 26, thereby causing the anchors 26 to expand outwardly from body 22. The tops 27 of the inner part of the anchors 26 are angled to allow lateral progressive horizontal movement of the anchor 26 itself.

3. In the present implant 20, the dentist can choose between different implant models with 1, 2, 3, 4, or more anchors 26, depending upon the density of the bone 600 and space and location requirements. That is, the dentist has more options and can choose the optimum implant design based upon the parameters of (1) the number of anchors 26, (2) anchor shape, and (3) anchor size (i.e. height H and width W). The diameter and the height of implant 20 can also be chosen to best fit the need of the implant situation.

4. In the present implant 20, the anchors 26 can have different shapes such as rectangular, square, circular, or elliptical depending upon the size of the implant body 22 and the force needed. In an embodiment, the inner section of the anchors 26 is threaded to accept the healing/stump screw 500.

5. In the present implant 20, there are no lateral fissures or openings between anchor 26 and body 22. When screwed into the bone 600 the anchor's thread is perfectly aligned with the implant body 22 thread and therefore does not catch bone residuals nor blood/tissues. By contrast, many prior art implants are open at the bottom (i.e. not sealed). This exposes tissue when healing screw 500 is removed. In an embodiment, the internal cavity of implant body 22 is somewhat sealed because anchors 26 closely fit into an opening 25 in body 22. Additional sealing can be provided by various sealing means/devices.

6. In the present implant 20, when anchors 26 expand into the bone 600, a portion of the anchor remains in body 22. As such, a seal is assured with no exposure of tissues/bone being possible when removing the healing screw 500 and inserting the stump screw 500.

7. In the present implant 20, in cases when a healing screw 500 is not used and the crown is immediately installed after the implant installation, anchors 26 provide a superior mechanical seal, both vertical and longitudinal to the masticatory loads, than is provided by simple coils of the current design implants. In this case bone integration has not yet occurred, and anchors 26 provide an immediate mechanical anchoring which is not provided by traditional implants.

8. In the present implant 20, in the case of porous bone or “soft” bone tissue, the anchors 26 increasing thickness provides a greater mechanical seal and immediate anchoring. Furthermore by horizontally compressing the bone tissues, anchors 26 increase the local density of the bone itself and can promote faster and increased bone integration.

9. In an embodiment, mechanical means are provided to hold anchor 26 in the unexpanded state, so that it will not fall out of body 22 during handling of implant 20 prior to insertion into the bone 600. For example, the surface of anchor 26 could include friction enhancing bumps so that it is friction fit into opening 25. Then it would not become detached during normal handling, but the friction would break under pressure from healing/stump screw 500 when turned by a manual screwdriver or power tool. Another holding means would be to use a bio-compatible adhesive.

10. Because anchor 26 provides a better immediate grip of the bone, the size of the hole into which implant 20 is screwed can be larger that used with standard implants.

11. In an embodiment a sealing device 80 is used to seal expandable dental implant 20 before the insertion of screw 500. The sealing device 80 allows screw 500 to be inserted and removed multiple times without allowing microbes to pass from the patient's mouth through opening 25 and into bone 600.

In terms of use, a method for implanting a dental implant in the bone 600 of the jaw of a patient includes: (refer to FIGS. 1-37)

(a) providing an expandable dental implant 20 including;
a body 22 having a longitudinal axis 24;
an opening 25 disposed in the body 22;
an anchor 26 which is slidably received by the opening 25;
the anchor 25 slidable in a direction perpendicular to the longitudinal axis 24;
the anchor 25 having an inner part 27 which is beveled;

(b) implanting the expandable dental implant 20 in the bone 600;

(c) providing a screw 500 which is threadably receivable by the body 22; and,

(d) screwing the screw 500 into the body 22 along the longitudinal axis 24 so that the screw 500 contacts the inner part 27 of the anchor 26 and urges the anchor 26 outward perpendicular to the longitudinal axis 24 and into the bone 600.

The method further including:

in (a) a plurality of the expandable dental implants 20 being available, the plurality including implants having different numbers of openings 25, different circumferential spacing of openings 25, different size openings 25, and different shape openings 25; and,

before (b), selecting the implant which is best suited to the specific needs of the patient.

Another method for implanting a dental implant in the bone of the jaw of a patient, includes:

(a) providing an expandable dental implant, the expandable dental implant including;
a body having a longitudinal axis;
an opening disposed in the body;
an anchor which is slidably received by the opening;
the anchor slidable in a direction perpendicular to the longitudinal axis;
the anchor having an inner part which is beveled;
a sealing device for sealing the body;

(c) providing a screw which is threadably receivable by the body;

(b) implanting the expandable dental implant in the bone;

(d) inserting the sealing device into the body along the longitudinal axis so that the sealing device contacts the inner part of the anchor and urges the anchor outward perpendicular to the longitudinal axis and into the bone; and,

(e) after (d), screwing the screw into the body.

The embodiments of the expandable dental implant and method of use described herein are exemplary and numerous modifications, combinations, variations, and rearrangements can be readily envisioned to achieve an equivalent result, all of which are intended to be embraced within the scope of the appended claims. Further, nothing in the above-provided discussions of the expandable dental implant and method should be construed as limiting the invention to a particular embodiment or combination of embodiments. The scope of the invention is defined by the appended claims.

I claim:

1. An expandable dental implant for implantation in the bone of the jaw of a patient, the expandable dental implant comprising:
a body having a longitudinal axis;
an opening disposed in said body;
an anchor is slidably received by said opening; and,
said anchor slidable in a direction perpendicular to said longitudinal axis.

2. The expandable dental implant according to claim 1, the expandable dental implant cooperating with a screw, the expandable dental implant further including:
said anchor having an inner part which is beveled, so that when the screw is screwed along said longitudinal axis the screw contacts said inner part of said anchor and urges said anchor outward perpendicular to said longitudinal axis.

3. The expandable dental implant according to claim 1, the expandable dental implant cooperating with a screw, the expandable dental implant further including:
a sealing device for sealing said expandable dental implant;
said anchor having an inner part which is beveled, so that when said sealing device is inserted along said longitudinal axis said sealing device contacts said inner part of said anchor and urges said anchor outward perpendicular to said longitudinal axis; and,
the screw being threadably receivable by said body after said sealing device has been inserted.

4. The expandable dental implant according to claim 3, further including:
said sealing device being a screw.

5. The expandable dental implant according to claim 3, further including:
said body having a first threaded hole for receiving the screw, and a second hole for receiving said sealing device, said first threaded hole for receiving said screw having a larger diameter than said second hole for receiving said sealing device.

6. The expandable dental implant according to claim 1, further including:
said expandable dental implant having an unexpanded state in which said anchor does not outwardly project from said body, and an expanded state in which said anchor outwardly projects from said body;
said body having external threads; and,
said anchor having external threads which align with said external threads of said body when said expandable dental implant is in said unexpanded state.

7. The expandable dental implant according to claim 1, further including:
said expandable dental implant having an unexpanded state in which said anchor does not outwardly project from said body, and an expanded state in which said anchor outwardly projects from said body; and,
when said dental implant is in said expanded state, part of said anchor remaining in said body.

8. The expandable dental implant according to claim 1, further including:
retaining means for holding said anchor within said opening.

9. The expandable dental implant according to claim 1, further including:
said opening and said associated anchor being one of (1) rectangular, (2) square, (3) elliptical, and (4) circular.

10. The expandable dental implant according to claim 1, further including:
a plurality of said openings and said associated anchors, said plurality of said openings and said associated anchors circumferentially spaced around said body.

11. The expandable dental implant according to claim 10, further including:
said circumferential spacing being one of (1) two said openings and associated anchors spaced 180° apart, (2) three said openings and associated anchors spaced 120° apart, and (3) four said openings and associated anchors spaced 90° apart.

12. The expandable dental implant according to claim 1, further including:
two said openings and associated anchors, said two openings and associated anchors being of different shapes.

13. The expandable dental implant according to claim 1, further including:
two said openings and associated anchors, said two openings and associated anchors being of different sizes.

14. The expandable dental implant according to claim 1, further including:
a spacing of about 0.002 inches existing between said opening and said anchor.

15. The expandable dental implant according to claim 1, further including:
said anchor having a depth which determines how far said anchor will expand into the bone of the jaw.

16. The expandable dental implant according to claim 1, further including:
said anchor not being externally threaded; and,
said body not being externally threaded in the vicinity of said anchor.

17. The expandable dental implant according to claim 1, the expandable dental implant cooperating with a screw, and the patient having a mouth which contains microbes, the expandable dental implant further including:
sealing means for sealing said expandable dental implant so that the microbes from the patients mouth cannot pass through said opening and into the bone of the jaw.

18. The expandable dental implant according to claim 17, further including:
the screw including a gasket;
said body including a seat for said gasket; and,
when the screw is screwed into said body, said gasket forming a seal.

19. A method for implanting a dental implant in the bone of the jaw of a patient, comprising:
(a) providing an expandable dental implant, said expandable dental implant including;
a body having a longitudinal axis;
an opening disposed in said body;
an anchor which is slidably received by said opening;
said anchor slidable in a direction perpendicular to said longitudinal axis;
said anchor having an inner part which is beveled;
(b) implanting said expandable dental implant in the bone;
(c) providing a screw which is threadably receivable by said body;
(d) screwing said screw into said body along said longitudinal axis so that said screw contacts said inner part of said anchor and urges said anchor outward perpendicular to said longitudinal axis and into the bone.

20. A method for implanting a dental implant in the bone of the jaw of a patient, comprising:
(a) providing an expandable dental implant, said expandable dental implant including;
a body having a longitudinal axis;
an opening disposed in said body;
an anchor which is slidably received by said opening;
said anchor slidable in a direction perpendicular to said longitudinal axis;
said anchor having an inner part which is beveled;
a sealing device for sealing said body;
(c) providing a screw which is threadably receivable by said body;
(b) implanting said expandable dental implant in the bone;
(d) inserting said sealing device into said body along said longitudinal axis so that said sealing device contacts said inner part of said anchor and urges said anchor outward perpendicular to said longitudinal axis and into the bone; and,
(e) after (d), screwing said screw into said body.
